(19) United States
(12) Patent Application Publication
(10) Pub. No.: US 2024/0110112 A1
(43) Pub. Date: Apr. 4, 2024

(54) FUEL PRODUCTION SYSTEM AND FUEL PRODUCTION METHOD

(71) Applicant: HONDA MOTOR CO., LTD., Tokyo (JP)

(72) Inventors: Hiroshi CHISHIMA, Saitama (JP); Kohtaro HASHIMOTO, Saitama (JP)

(21) Appl. No.: 18/479,120

(22) Filed: Oct. 2, 2023

(30) Foreign Application Priority Data
Oct. 4, 2022 (JP) 2022-160493

(51) Int. Cl. C10J 3/72; C10L 1/04

(52) U.S. Cl. CPC C10J 3/723; C10L 1/04; C10J 2200/15; C10J 2300/0916; C10J 2300/1656; C10J 2300/1684

(57) ABSTRACT

A fuel production system and a fuel production method are provided which can efficiently perform adjusting of a synthesis gas composition by hydrogen supply, while suppressing the generated amount of carbon dioxide by a system overall. A fuel production system includes: a gasification furnace which gasifies a biomass raw material to generate a synthesis gas containing hydrogen and carbon monoxide; a liquid fuel production device which produces a liquid fuel from the synthesis gas generated by the gasification furnace; a hydrogen supply pump which supplies hydrogen to a raw material supply area or a synthesis gas discharge area; a temperature sensor which detects a temperature of the gasification furnace; and a controller which switches a hydrogen supply location by the hydrogen supply pump between the raw material supply area and synthesis gas discharge area, based on the temperature detected by the temperature sensor.

This application is based on and claims the benefit of priority from Japanese Patent Application No. 2022-160493, filed on 4 Oct. 2022, the content of which is incorporated herein by reference.

### BACKGROUND OF THE INVENTION

### Field of the Invention

The present invention relates to a fuel production system and a fuel production method. In more detail, it relates to a fuel production system and a fuel production method which produce a liquid fuel based on a biomass raw material and renewable energy.

### Related Art

In recent years, as a substitute for fossil fuels, electrically synthesized fuels have gained attention which are made with hydrogen produced using electricity generated from renewable energy and a carbon source such as biomass or carbon dioxide discharged from factories.

A general sequence of producing liquid fuel such as methanol and gasoline with biomass as the raw material is as follows. In other words, a liquid fuel is produced from a biomass raw material through a gasifying step of gasifying a biomass raw material subjected to a predetermined pretreatment together with water and oxygen in a gasification furnace to generate a synthesis gas containing hydrogen and carbon monoxide; a scrubbing step of scrubbing the generated synthesis gas to remove tar; a H2/CO ratio adjusting step of adjusting the H2/CO ratio of the synthesis gas subjected to the scrubbing step to a target ratio according to a liquid fuel sought to be produced; a desulfurizing step of removing sulfur components from the synthesis gas subjected to the H2/CO ratio adjusting step; and a fuel producing step of producing the liquid fuel from the synthesis gas subjected to the desulfurizing step.

Herein, H2/CO of the synthesis gas generated through a gasifying step does not achieve the target ratio in most cases, and enters a hydrogen deficient state. Patent Document 1 discloses technology for adjusting the H2/CO ratio of synthesis gas discharged from a gas furnace, by supplying hydrogen generated by an electrolyzer generating hydrogen from water using a renewable energy into a gas furnace or a raw material supply path of a biomass raw material. According to the technology disclosed in Patent Document 1, it is possible to suppress the generated amount of carbon dioxide in the overall fuel production system.

Patent Document 1: Japanese Unexamined Patent Application, Publication No. 2021-147504

### SUMMARY OF THE INVENTION

However, there are cases where the proportion of supplied hydrogen being consumed in the generation of byproducts increases according to the operating conditions of the gasification furnace, and an improvement in the production efficiency of different fuels has been demanded.

The present invention has an object of providing a fuel production system and a fuel production method which can efficiently perform adjustment of synthesis gas composition by hydrogen supply, while suppressing the generated amount of carbon dioxide by the overall system. Then, consequently it contributes to higher efficiency in energy.

A fuel production system for producing a liquid fuel from a biomass raw material (for example, the fuel production system 1 described later) according to a first aspect of the present invention includes: a gasification furnace (for example, the gasification furnace 30 described later) which gasifies a biomass raw material to generate a synthesis gas containing hydrogen and carbon monoxide; a liquid fuel production device (for example, the liquid fuel production device 4 described later) which produces a liquid fuel from the synthesis gas generated by the gasification furnace; a hydrogen supply device (for example, the hydrogen supply pump 64 described later) which supplies hydrogen to a raw material supply area (for example, the raw material supply area A described later) including inside the gasification furnace and inside a raw material supply path (for example, the raw material supply path 20 described later) of biomass raw material leading to the gasification furnace, or a synthesis gas discharge area (for example, the synthesis gas discharge area B described later) at which the synthesis gas is discharged from the gasification furnace; a temperature detector (for example, the temperature sensor 312 described later) which detects a temperature of the gasification furnace; and a controller (for example, the controller 7 described later) which switches a hydrogen supply location by the hydrogen supply device between the raw material supply area and the synthesis gas discharge area, based on the temperature detected by the temperature detector.

According to a second aspect of the present invention, the fuel production system as described in the first aspect further includes: an electrolyzer (for example, the electrolyzer 60 described later) which generates hydrogen from water by way of electrical power generated using a renewable energy, in which the hydrogen supply device supplies the hydrogen generated by the electrolyzer to the raw material supply area or the synthesis gas discharge area.

According to a third aspect of the present invention, in the fuel production system as described in the first or second aspect, the controller switches a hydrogen supply location by the hydrogen supply device from the raw material supply area to the synthesis gas discharge area, when a temperature detected by the temperature detector is no more than a predetermined value.

According to a fourth aspect of the present invention, in the fuel production system as described in any one of the first to third aspects, the controller controls a hydrogen supply amount by the hydrogen supply device to adjust an H₂/CO ratio of synthesis gas flowing to the synthesis gas discharge area.

A fuel production method for producing a liquid fuel from a biomass raw material according to a fifth aspect of the present invention includes: a synthesis gas generating step of gasifying the biomass raw material and generating a synthesis gas containing hydrogen and carbon monoxide in a gasification furnace; a liquid fuel producing step of producing the liquid fuel from the synthesis gas generated in the synthesis gas generating step; a hydrogen supplying step of supplying hydrogen to a raw material supply area including inside of the gasification furnace and inside a raw material supply path of the biomass raw material leading to the gasification furnace, or to a synthesis gas discharge area at which the synthesis gas is discharged from the gasification furnace; a temperature detecting step of detecting a temperature of the gasification furnace; and a switching step of switching a hydrogen supply location by the hydrogen supplying step between the raw material supply area and the synthesis gas discharge area, based on the temperature detected in the temperature detecting step.

According to the present invention, it is possible to efficiently perform adjustment of the synthesis gas composition by hydrogen supply, while suppressing the generated amount of carbon dioxide by the system overall.

### BRIEF DESCRIPTION OF THE DRAWINGS

FIG. 1 is a view showing the configuration of a fuel production system according to an embodiment of the present invention;

FIG. 2 is a functional block diagram of a controller of the fuel production system according to an embodiment of the present invention;

FIG. 3 is a graph showing the relationships between hydrogen concentration in introduced gas supplied to a gasification furnace at 900° C., and the gasification rate in a gasification furnace, and generated amounts of tar and char;

FIG. 4 is a graph showing the relationships between hydrogen concentration in introduced gas supplied to a gasification furnace at 700° C., and the gasification rate in a gasification furnace, and generated amounts of tar and char;

FIG. 5 is a graph showing the relationships between hydrogen concentration in introduced gas supplied to a gasification furnace at 700° C., and the concentrations of various gases in the synthesis gas generated by the gasification furnace;

FIG. 6 is a graph showing the relationships of hydrogen concentration in introduced gas supplied to a gasification furnace at 700° C., and amounts of various gases generated by the gasification furnace;

FIG. 7 is a flowchart showing an example of the flow of processing in a case of a hydrogen supply location in hydrogen supply processing executed by a controller of a fuel production system according to an embodiment of the present invention being a raw material supply area; and

FIG. 8 is a flowchart showing an example of the flow of processing in a case of a hydrogen supply location in hydrogen supply processing executed by a controller of a fuel production system according to an embodiment of the present invention being a synthesis gas discharge area.

### DETAILED DESCRIPTION OF THE INVENTION

Hereinafter, a fuel production system 1 according to an embodiment of the present invention will be explained while referencing the drawings.

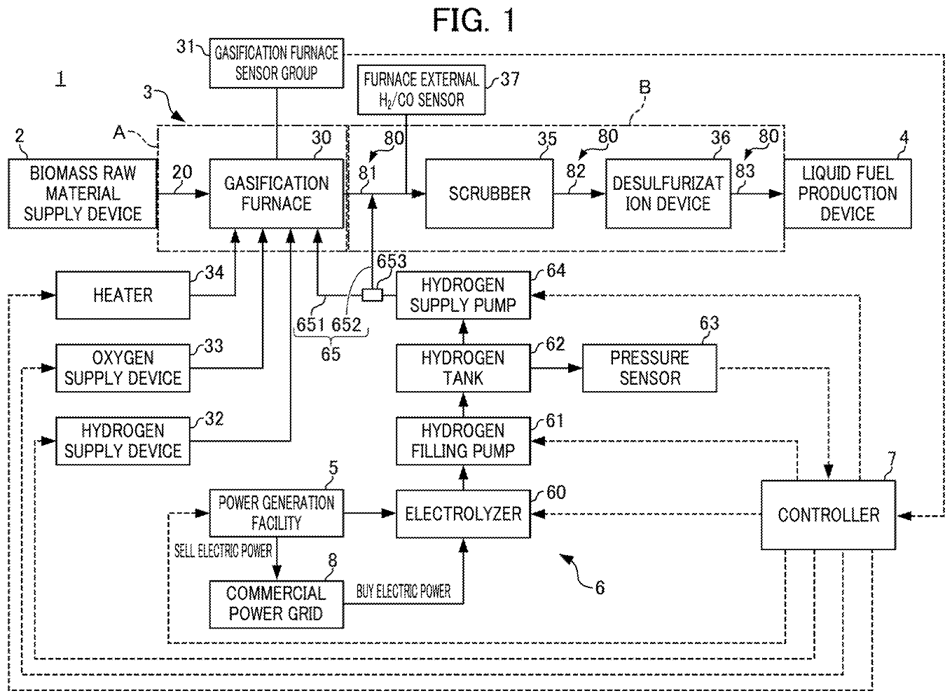

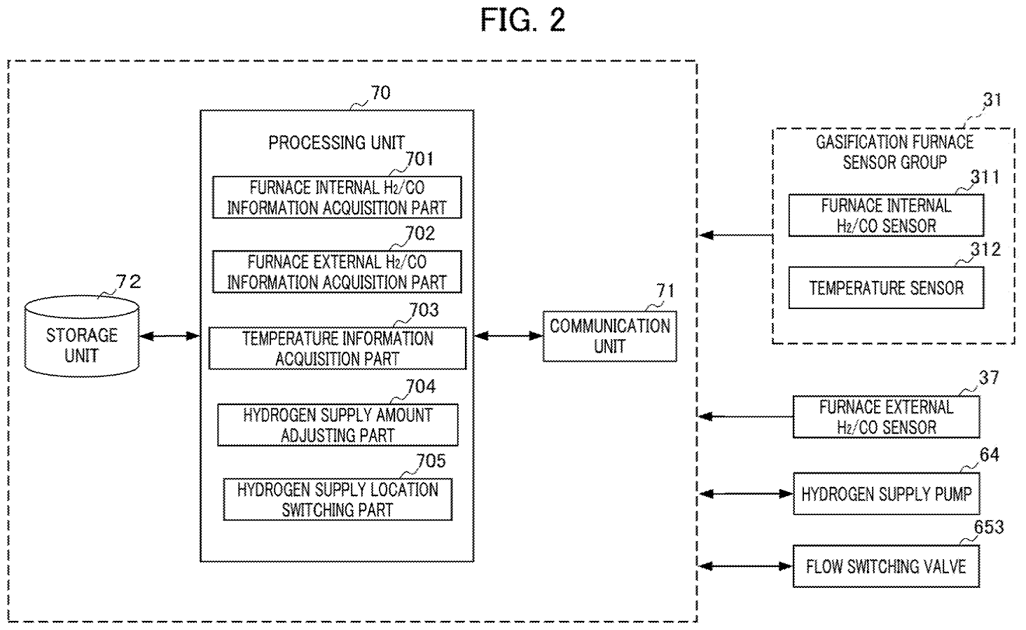

FIG. 1 is a view showing the configuration of the fuel production system 1 according to the present embodiment. FIG. 2 is a functional block diagram of a controller 7 of the fuel production system 1 according to the present embodiment. The fuel production system 1 includes: a biomass raw material supply device 2 that supplies biomass raw material; a gasifier 3 that generates synthesis gas containing hydrogen and carbon monoxide produced by gasifying the biomass raw material supplied from the biomass raw material supply device 2; a liquid fuel production device 4 that produces a liquid fuel from the synthesis gas supplied from the gasifier 3; a power generating facility 5 that generates power using a renewable energy; a hydrogen generation supply device 6 that generates hydrogen from water by way of the electric power generated in the power generating facility 5, and supplies the generated hydrogen to the gasifier 3; and a controller 7 that controls the gasifier 3, power generating facility 5 and hydrogen generation supply device 6, and produces a liquid fuel from biomass raw material using these.

The biomass raw material supply device 2 conducts a predetermined pretreatment on the biomass raw material such as rice husk, bagasse and wood, and supplies the biomass raw material subjected to this pretreatment to a gasification furnace 30 of the gasifier 3 via a raw material supply path 20. Herein, a drying step of drying the raw material, pulverization step of pulverizing the raw material, etc. are included in the pretreatment on the biomass raw material. It should be noted that the present disclosure refers to the inside of the gasification furnace 30 and inside the raw material supply path 20 as a raw material supply area A.

The gasifier 3 includes: the gasification furnace 30 which gasifies the biomass raw material supplied via the raw material supply path 20; a gasification furnace sensor group 31 configured by a plurality of sensors detecting the state inside the gasification furnace 30; a water supply device 32 that supplies water into the gasification furnace 30; an oxygen supply device 33 that supplies oxygen into the gasification furnace 30; a heater 34 that heats the gasification furnace 30; a scrubber 35 that scrubs the synthesis gas discharged from the gasification furnace 30; a desulfurization device 36 that removes sulfur components from the synthesis gas scrubbed by the scrubber 35, and supplies to the liquid fuel production device 4; and an furnace external H2/CO sensor 37. The synthesis gas discharged from the gasification furnace 30 is supplied to the liquid fuel production device 40 via a synthesis gas flow passage 80. The synthesis gas flow passage 80 includes a first synthesis gas flow passage 81 communicating the gasification furnace 30 and scrubber 35; a second synthesis gas flow passage 82 communicating the scrubber 35 and desulfurization device 36; and a third synthesis gas flow passage 83 communicating the desulfurization device 36 and liquid fuel production device 40. It should be noted that, in the present disclosure, a region including the inside of the first synthesis gas flow passage 81, inside of the scrubber 35, inside of the second synthesis gas flow passage 82, inside of desulfurization device 36, and inside of the third synthesis gas flow passage 83, i.e. a region in which synthesis gas is discharged from the gasification furnace 30, is referred to as synthesis gas discharge region B.

The water supply device 32 supplies water stored in a water tank (not shown) into the gasification furnace 30. The oxygen supply device 33 supplies the oxygen stored in an oxygen tank (not shown) into the gasification furnace 30. The heater 34 heats the gasification furnace 30, by consuming fuel supplied from a fuel tank (not shown) and/or electric power supplied from a power supply (not shown). The water supply amount from the water supply device 32 to the gasification furnace 30, oxygen supply amount from the oxygen supply device 33 into the gasification furnace 30, and input heat quantity from the heater 34 to the gasification furnace 30 are controlled by the controller 7. It should be noted that, in the fuel production system 1 according to the present embodiment, there are cases where it is not necessary to actively supply water from the water supply device 32 to the gasification furnace 30, by supplying hydrogen from the hydrogen generation supply device 6 described later to the raw material supply area A.

If charging water, oxygen, hydrogen, heat, etc. by the above such water supply device 32, oxygen supply device 33, heater 34 and hydrogen generation supply device 6 into the gasification furnace 30 to which the biomass raw material was charged, a plurality of types of gasification reactions and the reverse reaction thereto as shown in the below Formulas (1-1) to (1-8) progress within the gasification furnace 30, and synthesis gas containing hydrogen, carbon monoxide, carbon dioxide, and byproducts such as methane is generated.

### Chem. 1

C+O₂⇄CO₂ (1-1)

C+½O₂⇄CO (1-2)

C+CO₂⇄2CO (1-3)

CO+½O₂⇄CO₂ (1-4)

C+H₂O⇄CO+H₂ (1-5)

CO+H₂O⇄CO₂+H₂ (1-6)

CO+3H₂⇄CH₄+H₂O (1-7)

CO₂+4H₂⇄CH₄+2H₂O (1-8)

The gasification furnace sensor group 31, for example, is configured by a pressure sensor 63 that detects the pressure inside of the gasification furnace 30; a temperature sensor 312 that detects the temperature inside the gasification furnace 30; a CO₂ sensor that detects the carbon dioxide inside the gasification furnace 30; a CO sensor that detects the carbon monoxide inside the gasification furnace 30; an furnace internal H₂/CO sensor 311 that detects a H₂/CO ratio corresponding to the ratio of hydrogen to carbon monoxide in the synthesis gas inside the gasification furnace 30, etc. The CO sensor is configured by a constant potential electrolytic sensor or the like that detects carbon monoxide within the gasification furnace 30, for example. The detection signals of these sensors constituting the gasification furnace sensor group 31 are sent to the controller 7.

The furnace external H₂/CO sensor 37 is provided within the synthesis gas discharge area B, and detects a synthesis gas H₂/CO ratio flowing in the synthesis gas discharge area B. The furnace external H₂/CO sensor 37 is provided to at least any of inside the first synthesis gas flow passage 81, inside the second synthesis gas flow passage 82 and inside the third synthesis gas flow passage 83, and detects the H₂/CO ratio of synthesis gas flowing within the synthesis gas flow passage 80. In the present embodiment, the furnace external H₂/CO sensor 37 is provided within the first synthesis gas flow passage 81; however, it may be provided within the second synthesis gas flow passage 82, or may be provided within the third synthesis gas flow passage 83.

The gasifier 3 adjusts the H2/CO ratio of synthesis gas to a predetermined target value according to the liquid fuel sought to be produced, by mixing hydrogen supplied from the hydrogen generation supply device 6 described later, to the synthesis gas generated by the gasification reaction and reverse reaction thereto shown in the above Formulas (1-1) to (1-8), and then supplies this synthesis gas to the liquid fuel production device 4.

The liquid fuel production device 4 includes a methanol synthesis device, MTG (Methanol To Gasoline) synthesis device, FT (Fischer Tropsch) synthesis device, upgrading device, etc., and produces a liquid fuel such as methanol and gasoline from the synthesis gas adjusted to a predetermined H₂/CO ratio in the gasifier 3, using these.

The power generating facility 5 is configured by a wind power plant which generates power from wind power, which is a renewable energy, a solar power plant which generates power by sunlight, which is a renewable energy, or the like. The power generating facility 5 is connected to the hydrogen generation supply device 6, and can supply electric power generated using a renewable energy in the wind power plant, solar power plant, etc. to the hydrogen generation supply device 6. In addition, the power generating facility 5 is also connected with a commercial power grid 8. For this reason, a part or all of the electric power generated in the power generating facility 5 can be supplied to the commercial power grid 8, and can be sold to the power company.

The hydrogen generation supply device 6 includes an electrolyzer 60, hydrogen filling pump 61, hydrogen tank 62, pressure sensor 63, and a hydrogen supply pump 64 as a hydrogen supply device, generates hydrogen from the electric power supplied from the power generating facility 5 using these, and supplies the generated hydrogen to the gasifier 3.

The electrolyzer 60 is connected with the power generating facility 5, and generates hydrogen by electrolysis from water by way of the electric power supplied from the power generation facility 5. In addition, the electrolyzer 60 is connected with the commercial power grid 8. For this reason, the electrolyzer 60 becomes able to generate hydrogen not only by the electric power supplied from the power generating facility 5, but also electric power supplied from the commercial power grid 8 by purchasing from a power company. The hydrogen generation amount by the electrolyzer 60 is controlled by the controller 7.

The hydrogen filling pump 61 compresses hydrogen generated by the electrolyzer 60, and fills into the hydrogen tank 62. The hydrogen filling amount of the hydrogen filling pump 61 is controlled by the controller 7. The hydrogen tank 62 stores the hydrogen compressed by the hydrogen filling pump 61. The pressure sensor 63 detects the tank internal pressure of the hydrogen tank 62, and sends the detection signal to the controller 7. The hydrogen residual amount of the hydrogen tank 62 is calculated by the controller 7 based on the detection signal of the pressure sensor 63. Therefore, in the present embodiment, a hydrogen residual amount acquisition means for acquiring the hydrogen residual amount in the hydrogen tank 62 is configured by the pressure sensor 63 and the controller 7.

The hydrogen supply pump 64 supplies the hydrogen stored in the hydrogen tank 62 to the gasifier 3. The hydrogen supply pump 64 supplies the hydrogen stored in the hydrogen tank 62 via the hydrogen supply path 65 to the raw material supply area A or synthesis gas discharge area B. The hydrogen supply location by the hydrogen supply pump 64 of the raw material supply area A may be inside the raw material supply path 20, or may be inside the gasification furnace 30, for example. In the present embodiment, the hydrogen supply location of the raw material supply area A is inside the gasification furnace 30. The hydrogen supply location by the hydrogen supply pump 64 of the synthesis gas discharge area B, for example, may be inside the first synthesis gas flow passage 81, may be inside the second synthesis gas flow passage 82, may be inside the third synthesis gas flow passage 83, may be inside the scrubber 35, or may be inside the desulfurization device 36. In the present embodiment, the hydrogen supply location of the synthesis gas discharge area B is inside the first synthesis gas flow passage 81.

The hydrogen supply path 65 includes a first hydrogen supply path 651 which connects between the hydrogen supply pump 64 and gasification furnace 30 to be able to flow hydrogen; and a second hydrogen supply path 652 branches from the first hydrogen supply path 651 via a flow switching valve 653, and is connected to the first synthesis gas flow passage 81 through which hydrogen can flow. The flow switching valve 653 is a device which performs opening/closing or switching of a flow path, by controlling the opening/closing state of a plurality of values provided inside. In other words, the hydrogen supply location from the hydrogen supply pump 64 is switched between inside the gasification furnace 30 and inside the first synthesis gas flow passage 81, by controlling the opening/closing operation of valves of the flow switching valve 653.

The controller 7 is a computer which controls a hydrogen supply amount from the hydrogen supply device 32, oxygen supply amount from the oxygen supply device 33, input heat amount by the heater 34, hydrogen generation amount by the electrolyzer 60, and hydrogen filling amount by the hydrogen filling pump 61, based on detection signals, etc. from various sensors such as the gasification furnace sensor group 31 and pressure sensor 63. In addition, based on the detection signals, etc. from various sensors from the gasification furnace sensor group 31 and/or furnace external H₂/CO sensor 37, the controller 7 controls the hydrogen supply amount from the hydrogen supply pump 64 to the gasifier 3, and executes hydrogen supply processing of switching the hydrogen supply location of the gasifier 3 from the hydrogen supply pump 64. The hydrogen supply processing executed by the controller 7 is described later.

Next, the influence on the gasification rate, gas composition in the gasification furnace 30, etc. when supplying hydrogen into the gasification furnace 30 will be explained.

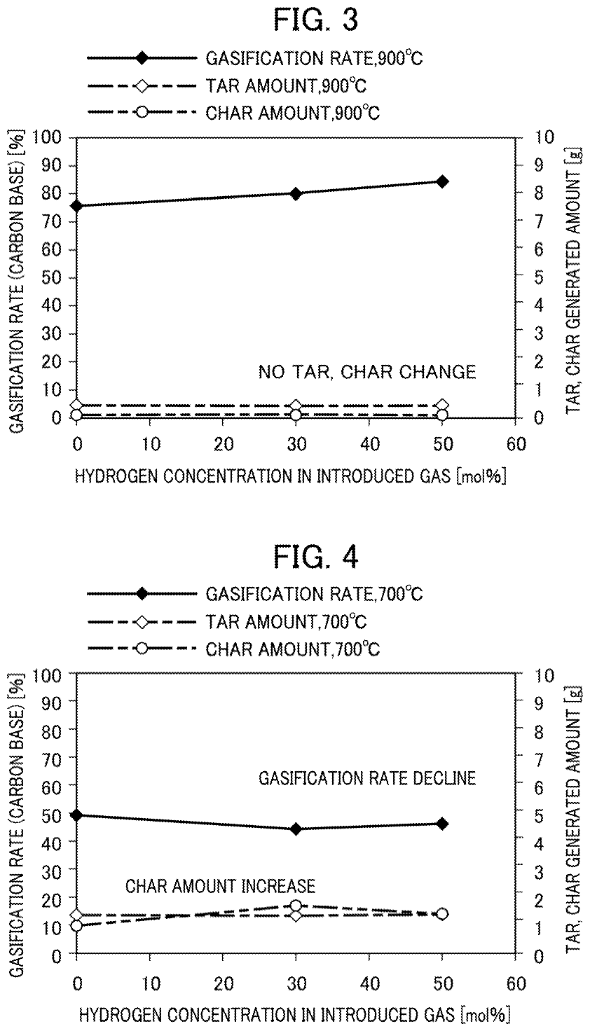

First, the influence on the gasification rate in the gasification furnace 30 by hydrogen supply will be explained while referencing FIG. 3 and FIG. 4.

FIG. 3 and FIG. 4 are graphs showing the relationships between hydrogen concentration (mol %) in the introduced gas supplied to the gasification furnace 30, gasification rate (%) calculated on carbon basis in the gasification furnace 30, and generated amounts (g) of tar and char, which are byproducts. The solid lines in FIG. 3 and FIG. 4 indicate the gasification rate according to the hydrogen supply, the one-dot chain lines indicate the generated amount of tar, and the two-dot chain lines indicate the generated amount of char. The results shown in FIG. 3 are obtained by performing simulation under conditions of temperature within the gasification furnace 30 of 900° C. and S/C of 3. The results shown in FIG. 4 are obtained by performing simulation under conditions of temperature within the gasification furnace 30 of 700° C. and S/C of 3. On the other hand, there are cases of the gasification rate of the gasification furnace 30 according to hydrogen supply declining due to the operating conditions of the gasification furnace 30.

AS shown in FIG. 4, in the case of the temperature inside the gasification furnace 30 being 700° C., the gasification rate declines, and the generated amounts of char and tar increase, as the hydrogen concentration in the introduced gas become larger. On the other hand, as shown in FIG. 3, in the case of the temperature in the gasification furnace 30 being 900° C., the high gasification rate is obtained, and do not produce a change in generated amounts of char and tar, irrespective of the hydrogen concentration in the introduced gas. This is because inside the gasification furnace 30 is high temperature, and gasification sufficiently progresses; therefore, the influence on gasification suppression by hydrogen supply is curbed to be small. From the results shown in FIG. 3 and FIG. 4, the influence from hydrogen supply can be confirmed to differ according to the operating conditions of the gasification furnace 30. In addition, in the case of operating the gasification furnace 30 at low temperature, it could be confirmed that there is a trend for the gasification rate of the gasification furnace 30 to decline by hydrogen supply.

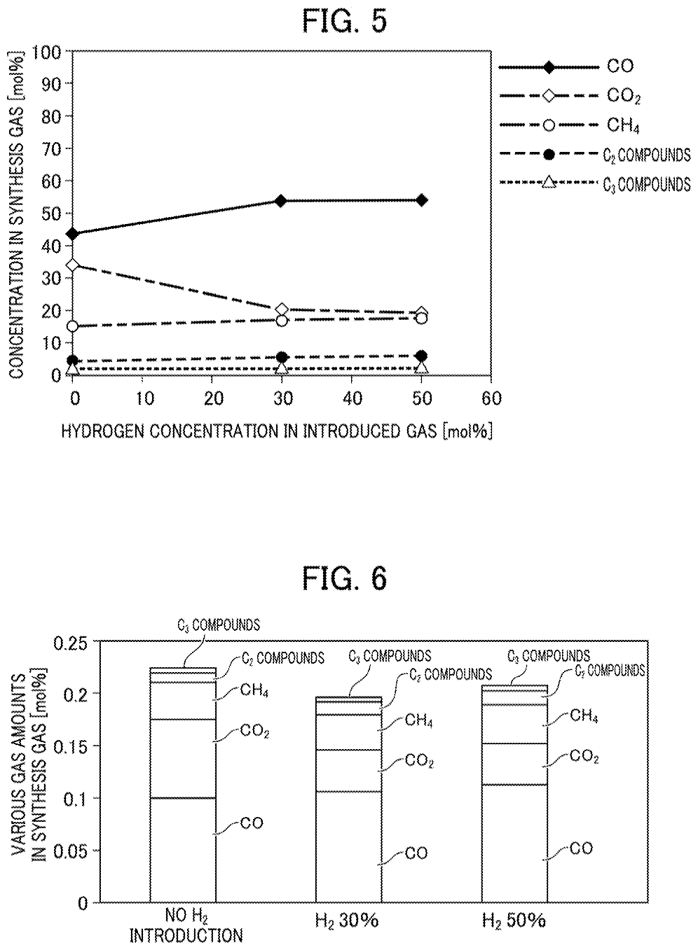

Next, the influence on gas composition of the synthesis gas by hydrogen supply will be explained while referencing FIG. 5 and FIG. 6.

FIG. 5 is a graph showing a relationship between hydrogen concentration (mol %) in the introduced gas supplied to the gasification furnace 30, and concentration (mol %) of various gases in the synthesis gas generated by the gasification furnace 30. The solid line in FIG. 5 indicates the concentration of carbon monoxide in the synthesis gas, the one-dot chain line indicates the concentration of carbon dioxide in the synthesis gas, the two-dot chain line indicates the concentration of methane in the synthesis, the long dashed line indicates the concentration of C₂ compounds in the synthesis gas, and the short dashed line indicates the concentration of C₃ compounds in the synthesis gas. FIG. 6 is a graph showing the relationship between the hydrogen concentration (mol %) in the introduced gas supplied to the gasification furnace 30, and the amounts (mol) of various gases generated by the gasification furnace 30. The results shown in FIG. 5 and FIG. 6 are obtained by performing simulation under conditions of the temperature inside the gasification furnace 30 of 700° C. and S/C of 3.

As shown in FIG. 5, it could be confirmed that the proportion of carbon dioxide in the synthesis gas becomes smaller and the proportion of carbon monoxide becomes larger by the hydrogen supply to the gasification furnace 30. This is considered to be due to the reverse water gas shift reaction shown in the above Formula (1-6). When supplying hydrogen into the gasification furnace 30, carbon dioxide decreases and carbon monoxide increases by this this reverse water gas shift reaction. It is thereby possible to suppress the generated amount of carbon dioxide in the gasification furnace 30.

On the other hand, as shown in FIG. 6, it could be confirmed that the change in carbon monoxide as the absolute amount in the gasification furnace 30 is small accompanying hydrogen supply. As shown in FIG. 5 and FIG. 6, it could be confirmed that the methane generated amount inside the gasification furnace 30 increases with an increase in hydrogen supply amount to the gasification furnace 30, and the C₂ compounds also increased slightly. In other words, under the low temperature condition such as 700° C., methane and byproducts such as tar and char increase instead of carbon monoxide, even when supplying hydrogen to the gasification furnace 30. This is due to a part of the carbon monoxide obtained from the reverse water gas shift reaction of the above Formula (1-6) reacting with hydrogen supplied to the gasification furnace 30, and following the chemical reaction in the above Formula (1-7) in which methane is obtained. In addition, as shown in the above Formula (1-8), the carbon dioxide in the gasification furnace 30 also reacts with the supplied hydrogen, whereby methane is generated. In other words, in the case of operating the gasification furnace 30 at low temperature, even if performing hydrogen supply to the gasification furnace 30, although the carbon dioxide amount decreases, the increase amount of carbon monoxide is small, and does not contribute to an improvement in the fuel yield due to the hydrogen being consumed in the generation of methane having low fuel yield, and byproducts such as tar and char. In contrast, the present embodiment performs hydrogen supply processing of switching, with the object of an improvement in the production efficiency of fuel by hydrogen supply, the hydrogen supply location from the raw material supply area A to the synthesis gas discharge area B which is on the downstream side of the gasification furnace 30, and where the reaction generating the byproduct does not occur, based on the temperature inside the gasification furnace 30, etc.

Next, the configuration of hardware of the controller 7 executing the hydrogen supply processing will be explained. As shown in FIG. 2, the controller 7 includes a communication unit 71, storage unit 72, and processing unit 70.

The communication unit 71 controls communication performed with other devices such as the gasification furnace sensor group 31, furnace external H₂/CO sensor 37, electrolyzer 60, hydrogen supply pump 64, and flow switching valve 653. The communication unit 71 sends and receives detection signals, controls signals, etc. with these devices.

The storage unit 72 is a storage area of various programs for making a hardware group to function as the controller 7, various data, etc., and can be configured by ROM, RAM, flash memory, semiconductor drive (SSD) or hardware (HDD). More specifically, the storage unit 72 stores programs for causing each function of the present embodiment to execute in the processing unit 70, a control program of hydrogen supply processing, target values of H₂/CO ratio which is appropriate according to the type of liquid fuel to be produced and production device thereof, first switching determination value or second switching determination value described later, etc.

The processing unit 70 is an arithmetic unit configured by a processor, and reads out various programs and data from the storage unit 72 and executes predetermined data processing. The processor, for example, is a CPU (central processing unit), MPU (micro processing unit), SoC (system on a chip), DSP (digital signal processor), GPU (graphics processing unit), VPU (vision processing unit), ASIC (application specific integrated circuit), PLD (programmable logic device), FPGA (field-programmable gate array), or the like.

Next, the functional configuration of the processing unit 70 of the controller 7 for executing hydrogen supply processing in the fuel production system 1 will be explained while referencing FIG. 1 and FIG. 2. As shown in FIG. 2, the processing unit 70 includes a furnace internal H₂/CO information acquisition part 701, a furnace external H₂/CO information acquisition part 702, a temperature information acquisition part 703, a hydrogen supply amount adjustment part 704 and a hydrogen supply location switching part 705.

The furnace internal H₂/CO information acquisition part 701 executes processing of acquiring the furnace internal H₂/CO information indicating the H₂/CO ratio in the gasification furnace 30 detected by the furnace internal H₂/CO sensor 311. The furnace internal H₂/CO information acquisition part 701 acquires the furnace internal H₂/CO information by receiving a detection signal from the furnace internal H₂/CO sensor 311 via the communication unit 71.

The furnace external H₂/CO information acquisition part 702 executes processing of acquiring the furnace external H₂/CO information indicating the H₂/CO ratio in the synthesis gas inside the synthesis gas discharge area B detected by the furnace external H₂/CO sensor 37. The furnace external H₂/CO information acquisition part 702 acquires the furnace external H₂/CO information by receiving the detection signal from the furnace external H₂/CO sensor 37 via the communication unit 71.

The temperature information acquisition part 703 executes processing of acquiring temperature information indicating the temperature inside the gasification furnace 30 detected by the temperature sensor 312. The temperature information acquisition part 703 acquires the temperature information by receiving the detection signal from the temperature sensor 312 via the communication unit 71.

The hydrogen supply amount adjustment part 704 executes processing of adjusting the hydrogen supply amount supplied to the gasifier 3 by controlling the driving of the hydrogen supply pump 64. The hydrogen supply amount adjustment part 704 executes processing of stopping the supply of hydrogen or varying the hydrogen supply amount to the gasifier 3, based on the furnace internal H₂/CO information and furnace external H₂/CO information. The hydrogen supply amount adjustment part 704, for example, may increase the hydrogen supply amount in the case of the H₂/CO ratio being less than a predetermined target value, or may stop the supply of hydrogen in the case of the H₂/CO ratio exceeding the predetermined target value. The target value for the H₂/CO ratio in the synthesis gas may be set to a suitable value according to the type of liquid fuel to be produced and the production device thereof. For example, in the case of producing liquid fuel by FT synthesis or methanol synthesis, the target value for the H₂/CO ratio in the synthesis gas may be set to 2.

The hydrogen supply location switching part 705 executes processing of switching the hydrogen supply location in the gasifier 3, by controlling the opening/closing operation of the flow switching valve 653. The hydrogen supply location switching part 705 switches the hydrogen supply location by the hydrogen supply pump 64 between the raw material supply area A and synthesis gas discharge area B, based on the temperature information acquired by the temperature information acquisition part 703. In the present embodiment, the hydrogen supply location switching part 705 switches the hydrogen supply location by the hydrogen supply pump 64 between inside the gasification furnace 30 and inside the first synthesis gas flow passage 81. For example, the hydrogen supply location switching part 705 may switch the hydrogen supply location from inside the gasification furnace 30 to inside the first synthesis gas flow passage 81, when the temperature inside the gasification furnace 30 is no more than a predetermined value.

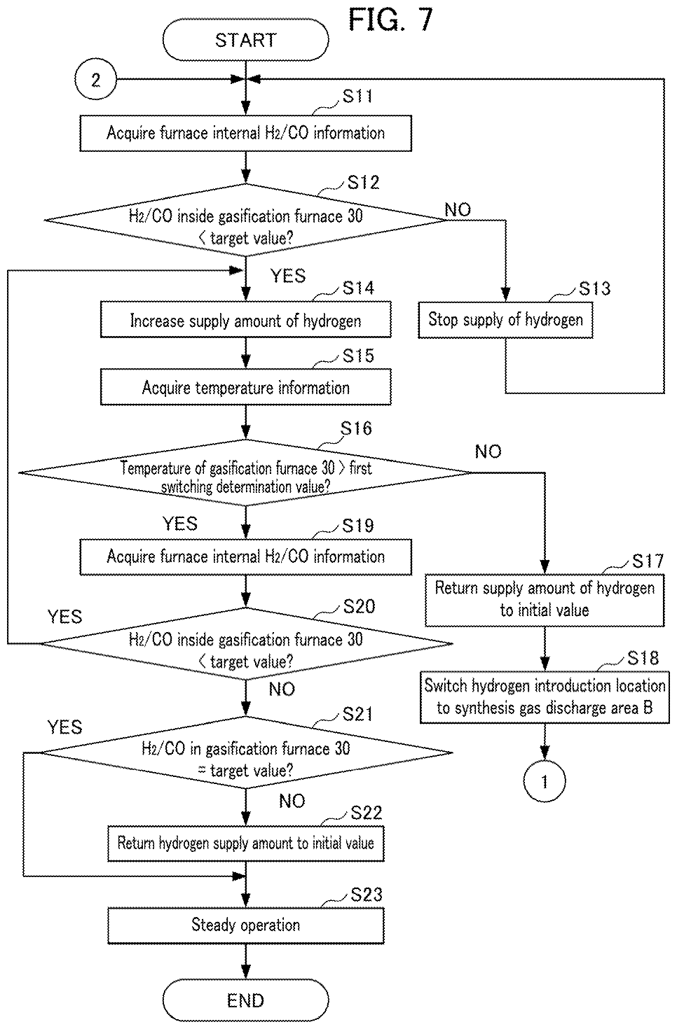

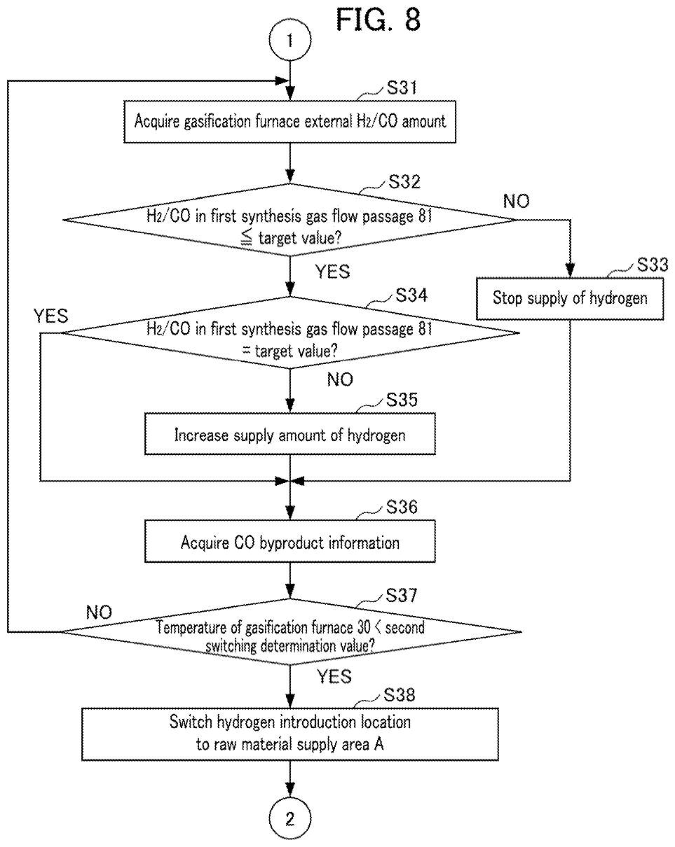

Next, an example of hydrogen supply processing executed by the processing unit 70 of the controller 7 will be explained while referencing FIG. 7 and FIG. 8. FIG. 7 is flowchart showing an example of the flow of processing in the case of the hydrogen supply location being the raw material supply area A, in the hydrogen supply processing executed by the processing unit 70 of the controller 7 in the fuel supply system 1. FIG. 8 is a flowchart showing an example of the flow of processing in the case of the hydrogen supply location being the synthesis gas discharge area B, in the hydrogen supply processing executed by the processing unit 70 of the controller 7 in the fuel supply system 1. The hydrogen supply processing is started at a timing at which the fuel supply system 1 including the controller 7 is activated, and starting the production of liquid fuel. It should be noted that, during the start of the hydrogen supply processing, the hydrogen supply location by the hydrogen supply pump 64 is set to inside the gasification furnace 30, and the hydrogen supply amount is set to a predetermined initial value.

As shown in FIG. 7, in Step S11, the furnace internal H₂/CO information acquisition part 701 acquires the furnace internal H₂/CO information indicating the H₂/CO ratio inside the gasification furnace 30 detected by the furnace internal H₂/CO sensor 311.

In Step S12, the hydrogen supply amount adjustment part 704 determines whether or not the H₂/CO ratio inside the gasification furnace 30 is less than a predetermined value, by comparing the furnace internal H₂/CO information acquired in Step S11 and the target value extracted from the storage unit 72. The hydrogen supply amount adjustment part 704 advances the processing to Step S13, in the case of determining that the H₂/CO ratio inside the gasification furnace 30 is at least the target value (NO in Step S12). Then, the hydrogen supply amount adjustment part 704 stops the supply of hydrogen from the hydrogen supply pump 64 to the gasification furnace 30 in Step S13, and then returns the processing to Step S11. On the other hand, the hydrogen supply amount adjustment part 704 advances the processing to Step S14, in the case of determining that the H₂/CO ratio inside the gasification furnace 30 is less than the target value (YES in Step S12).

In Step S14, the hydrogen supply amount adjustment part 704 increases the hydrogen supply amount from the hydrogen supply pump 64 to the gasification furnace 30.

In Step S15, the temperature information acquisition part 703 acquires the temperature information indicating the temperature inside the gasification furnace 30.

In Step S16, the hydrogen supply location switching part 705 determines whether the temperature inside the gasification furnace 30 indicated by the temperature information acquired in Step S15 is greater than the first switching determination value that is a predetermined value. The hydrogen supply location switching part 705 advances the processing to Step S17 in the case of determining that the temperature inside the gasification furnace 30 is no more than the first switching determination value (NO in Step S16). Then, in Step S17, the hydrogen supply amount adjustment part 704 returns the hydrogen supply amount to the initial value, and advances the processing to Step S18. In Step S18, the hydrogen supply location switching part 705 controls the opening/closing operation of the flow switching valve 653, and switches the hydrogen supply location by the hydrogen supply pump 64 from the gasification furnace 30 to the first synthesis gas flow passage 81 which is more to the downstream side than the gasification furnace 30. The flow of processing in the case of the hydrogen supply location being the first synthesis gas flow passage 81 will be described later. On the other hand, the hydrogen supply location switching part 705 advances the processing to Step S19 in the case of determining that the temperature inside the gasification furnace 30 exceeds the first switching determination value (YES in Step S16).

In Step S19, the furnace internal H₂/CO information acquisition part 701 acquires the furnace internal H₂/CO information.

In Step S20, the hydrogen supply amount adjustment part 704 determines whether the H₂/CO ratio inside the gasification furnace 30 is less than the target value, by comparing the furnace internal H₂/CO information acquired in Step S19 and the target value extracted from the storage unit 72. The hydrogen supply amount adjustment part 704 returns the processing to Step S14, in the case of determining that the H₂/CO ratio inside the gasification furnace 30 is less than the target value (YES in Step S20). On the other hand, the hydrogen supply amount adjustment part 704 advances the processing to Step S20, in the case of determining that the H₂/CO ratio inside the gasification furnace 30 is at least the target value (NO in Step S20).

In Step S21, the hydrogen supply amount adjustment part 704 determines whether the H₂/CO ratio inside the gasification furnace 30 equals the target value, by comparing the furnace internal H₂/CO information acquired in Step S19 and the target value extracted from the storage unit 72. The hydrogen supply amount adjustment part 704 advances the processing to Step S22, in the case of the H₂/CO ratio inside the gasification furnace 30 differing from the target value (NO in Step S21). Then, in Step S22, the hydrogen supply amount adjustment part 704 returns the hydrogen supply amount to the initial value, and then advances the processing to Step S23. On the other hand, the hydrogen supply amount adjusting part 704 advances the processing to Step S23 without going through Step S22, in the case of determining that the case of the H₂/CO ratio inside the gasification furnace 30 is equal to the target value (YES in Step S20).

In Step S23, the processing unit 70 executes hydrogen supply processing according to steady operation which does not change the hydrogen supply amount, and repeats processing from Step S11 after a predetermined time period elapse.

Next, an example of the flow of the hydrogen supply processing executed by the processing unit 70 after switching the hydrogen introduction location to the first synthesis gas flow passage 81 in Step S18 will be explained while referencing FIG. 8.

As shown in FIG. 7, in Step S31, the furnace external H₂/CO information acquisition unit 702 acquires furnace external H₂/CO information indicating the H₂/CO ratio in the first synthesis gas flow passage 81 detected by the furnace external H₂/CO sensor 37.

In Step S32, the hydrogen supply amount adjustment unit 704 determines whether the H₂/CO ratio of the first synthesis gas flow passage 81 is no more than the target value, by comparing the furnace external H₂/CO information acquired in Step S31 and the target value extracted from the storage unit 72. The hydrogen supply amount adjustment unit 704 advances the processing to Step S33, in the case of determining that the H₂/CO ratio of the first synthesis gas flow passage 81 exceeds the target value (NO in Step S32). Then, the hydrogen supply amount adjustment unit 704 stops the supply of hydrogen from the hydrogen supply pump 64 to inside the first synthesis gas flow passage 81 in Step S33, and advances the processing to Step S36. On the other hand, the hydrogen supply amount adjustment unit 704 advances the processing to Step S34, in the case of determining that the H₂/CO ratio in the first synthesis gas flow passage 81 is no more than the target value (YES in Step S32).

In Step S34, the hydrogen supply amount adjustment unit 704 determines whether the H₂/CO ratio in the first synthesis gas flow passage 81 is equal to the target value, by comparing the furnace external H₂/CO information acquired in Step S31 and the target value extracted from the storage unit 72. The hydrogen supply amount adjustment unit 704 advances the processing to Step S35, in the case of determining that the H₂/CO ratio in the first synthesis gas flow passage 81 differs from the target value (NO in Step S34). Then, in Step S35, the hydrogen supply amount adjustment unit 704 increases the hydrogen supply amount, and advances the processing to Step S36. On the other hand, the hydrogen supply amount adjustment unit 704 advances the processing to Step S36 without going through Step S35, in the case of determining that the H₂/CO ratio in the first synthesis gas flow passage 81 equals the target value (YES in Step S34).

In Step S36, the temperature information acquisition part 703 acquires the temperature information indicating the temperature inside the gasification furnace 30.

In Step S37, the hydrogen supply location switching part 705 determines whether the temperature inside the gasification furnace 30 indicated by the temperature information acquired in Step S36 is greater than a second switching determination value that is a predetermined value. The hydrogen supply location switching part 705 returns the processing to Step S31, in the case of determining that the temperature of the gasification furnace 30 is less than the second switching determination value (NO in Step S37). On the other hand, the hydrogen supply location switching part 705 advances the processing to Step S38, in the case of determining that the temperature of the gasification furnace 30 exceeds the second switching determination value (YES in Step S37). It should be noted that, in the example shown in FIG. 8, the second switching determination value is set to a value higher than the first switching determination value; however, the first switching determination value and the second switching determination value may be equal.

In Step S38, the hydrogen supply location switching part 705 controls the opening/closing operation of the flow switching valve 653, and switches the hydrogen supply location by the hydrogen supply pump 64 from inside the first synthesis gas flow passage 81 to inside the gasification furnace 30. Then, the processing unit 70 returns the processing to Step S11 shown in FIG. 7.

According to the fuel production system 1 related to the present embodiment, the following effects are exerted.

The fuel production system 1 according to the present embodiment is a fuel production system 1 for producing a liquid fuel from a biomass raw material, and includes: the gasification furnace 30 which gasifies the biomass raw material and generates a synthesis gas containing hydrogen and carbon monoxide; the liquid fuel production device 4 which produces a liquid fuel from the synthesis gas generated by the gasification furnace 30; the electrolyzer 60 that generates hydrogen from water from the electric power generated using a renewable energy; the hydrogen supply pump 64 which supplies hydrogen generated by the electrolyzer 60 to the raw material supply area A including inside the gasification furnace 30 and inside the raw material supply path 20 of biomass raw material reaching the gasification furnace 30, or the synthesis gas discharge area B at which the synthesis gas is discharged from the gasification furnace 30; the temperature sensor 312 which detects the temperature of the gasification furnace 30; and the controller 7 which switches the hydrogen supply location by the hydrogen supply pump 64 between the raw material suppl area A and synthesis gas discharge area B based on the temperature detected by the temperature sensor 312.

Herein, as mentioned above in the examples shown in FIG. 3 to FIG. 6, although it is possible to suppress the generated amount of carbon dioxide by supplying hydrogen to the gasification furnace 30, in the case of the temperature inside the gasification furnace 30 being low, there is a trend for the supplied hydrogen to be consumed in byproduct generation, and the increased amount of carbon monoxide having a high fuel yield decreasing. In contrast, with the fuel production system 1, based on the temperature inside the gasification furnace 30, the hydrogen supply location is switched between the raw material supply area A at which hydrogen is supplied to the gasification furnace 30 and the synthesis gas discharge area B which is downstream of the gasification furnace 30. It is thereby possible to curb the carbon dioxide amount generated inside the gasification furnace 30 while adjusting the H₂/CO ratio in the synthesis gas by setting the hydrogen supply location to the raw material supply area A when the temperature inside the gasification furnace 30 is high, and switch the hydrogen supply location to the downstream side of the gasification furnace 30, when the temperature inside the gasification furnace 30 is low. In other words, in the case of the generation effect of carbon monoxide by hydrogen supply to the gasification furnace 30 declining, and the generated amount of byproducts increasing, it is possible to switch the hydrogen supply location to the downstream side of the gasification furnace 30 at which the generation of the byproduct does not occur, and use the hydrogen only in the adjustment of the H₂/CO ratio. Consequently, it is possible to efficiently perform adjustment by hydrogen supply of the composition of the synthesis gas supplied to the liquid fuel production device, while suppressing the generated amount of carbon dioxide by the system overall. In addition, since the generated amount of byproduct can also be suppressed, the processing cost can also be reduced. Therefore, it is possible to maximize the improvement effect on the fuel production efficiency by the hydrogen supply, while suppressing the generated amount of carbon dioxide by the system overall.

In addition, the fuel production system 1 according to the present embodiment further includes the electrolyzer 60 which generates hydrogen from water by way of electric power produced using a renewable energy, in which the hydrogen supply pump 64 supplies the hydrogen generated by the electrolyzer 60 to the raw material supply area A or synthesis gas discharge area B. It is thereby possible to further suppress the generated amount of carbon dioxide by the system overall.

In addition, in the fuel production system 1 according to the present embodiment, the controller 7 switches the hydrogen supply location by the hydrogen supply pump 64 from the raw material supply area A to the synthesis gas discharge area B, when the temperature detected by the temperature sensor 312 is no more than a predetermined value. It is thereby possible to perform adjustment of synthesis gas composition and suppression of the generated amount of carbon dioxide by supplying hydrogen to the gasification furnace 30, and in the case of the temperature becomes low, switch so as to use hydrogen only in the adjustment of the synthesis gas composition. It is thereby possible to efficiently perform adjustment of synthesis gas composition by hydrogen supply, while suppressing the carbon dioxide amount generated from the gasification furnace 30.

In addition, in the fuel production system 1 according to the present embodiment, the controller 7 controls the hydrogen supply amount by the hydrogen supply pump 64, and adjusts the H₂/CO ratio of synthesis gas flowing to the synthesis gas discharge area B. Even in the case of switching the hydrogen supply location to the downstream side from the gasification furnace 30, it is thereby possible to more reliably supply synthesis gas of the desired H₂/CO ratio to the liquid fuel production device 4.

In addition, the fuel production method according to the present embodiment produces a liquid fuel from a biomass raw material, the method including: a synthesis gas generating step of gasifying the biomass raw material and generating synthesis gas containing hydrogen and carbon monoxide by the gasification furnace 30; a liquid fuel producing step of producing a liquid fuel from the synthesis gas generated in the synthesis gas generating step; a hydrogen supply step of supplying hydrogen from the raw material supply area A including inside the gasification furnace 30 and inside the raw material supply path 20 of the biomass raw material reaching the gasification furnace 30, or the synthesis gas discharge area B at which the synthesis gas is discharged from the gasification furnace 30; a temperature detecting step of detecting a temperature of the gasification furnace 30; and a switching step of switching the hydrogen supply location in the hydrogen supplying step between the raw material supply area A and the synthesis gas discharge area B, based on the temperature detected in the temperature detecting step. It is thereby possible to efficiently perform adjustment by hydrogen supply of the composition of synthesis gas used in the production of liquid fuel, while suppressing the generated amount of carbon dioxide by the system overall. In addition, since the generated amount of byproduct can also be suppressed, the processing cost can also be reduced. Therefore, it is possible to maximize the improvement effect on the fuel production efficiency by the hydrogen supply, while suppressing the generated amount of carbon dioxide by the system overall.

Although an embodiment of the present invention has been explained above, the present invention is not to be limited thereto. The configurations of detailed parts may be modified as appropriate within the scope of the gist of the present invention.

### EXPLANATION OF REFERENCE NUMERALS

1 fuel production system

4 liquid fuel production device

7 controller

20 raw material supply path

30 gasification furnace

60 electrolyzer

64 hydrogen supply pump (hydrogen supply device)

312 temperature sensor (temperature detector)

A raw material supply area

B synthesis gas discharge area

What is claimed is:

1. A fuel production system for producing a liquid fuel from a biomass raw material, the system comprising:
a gasification furnace which gasifies a biomass raw material to generate a synthesis gas containing hydrogen and carbon monoxide;
a liquid fuel production device which produces a liquid fuel from the synthesis gas generated by the gasification furnace;
a hydrogen supply device which supplies hydrogen to a raw material supply area including inside the gasification furnace and inside a raw material supply path of biomass raw material leading to the gasification furnace, or a synthesis gas discharge area at which the synthesis gas is discharged from the gasification furnace;
a temperature detector which detects a temperature of the gasification furnace; and
a controller which switches a hydrogen supply location by the hydrogen supply device between the raw material supply area and the synthesis gas discharge area, based on the temperature detected by the temperature detector.

2. The fuel production system according to claim 1, further comprising an electrolyzer which generates hydrogen from water by way of electrical power generated using a renewable energy,
wherein the hydrogen supply device supplies the hydrogen generated by the electrolyzer to the raw material supply area or the synthesis gas discharge area.

3. The fuel production system according to claim 1, wherein the controller switches a hydrogen supply location by the hydrogen supply device from the raw material supply area to the synthesis gas discharge area, when a temperature detected by the temperature detector is no more than a predetermined value.

4. The fuel production system according to claim 1, wherein the controller controls a hydrogen supply amount by the hydrogen supply device to adjust an H₂/CO ratio of synthesis gas flowing to the synthesis gas discharge area.

5. A fuel production method for producing a liquid fuel from a biomass raw material, the method comprising:
a synthesis gas generating step of gasifying the biomass raw material and generating a synthesis gas containing hydrogen and carbon monoxide in a gasification furnace;
a liquid fuel producing step of producing the liquid fuel from the synthesis gas generated in the synthesis gas generating step;
a hydrogen supplying step of supplying hydrogen to a raw material supply area including inside of the gasification furnace and inside a raw material supply path of the biomass raw material leading to the gasification furnace, or to a synthesis gas discharge area at which the synthesis gas is discharged from the gasification furnace;
a temperature detecting step of detecting a temperature of the gasification furnace; and
a switching step of switching a hydrogen supply location by the hydrogen supplying step between the raw material supply area and the synthesis gas discharge area, based on the temperature detected in the temperature detecting step.
